(19) United States
(12) Patent Application Publication
(10) Pub. No.: US 2009/0024975 A1
(43) Pub. Date: Jan. 22, 2009

(54) SYSTEMS, METHODS AND COMPUTER PRODUCTS FOR TRAVERSING DESIGN HIERARCHY USING A SCROLL MECHANISM

(75) Inventors: Karl L. Ladin, Rochester, MN (US); Chun-Tao Li, Rochester, MN (US); Salvatore N. Storino, Rochester, MN (US)

Correspondence Address: CANTOR COLBURN LLP - IBM ROCHESTER DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/778,926

(22) Filed: Jul. 17, 2007

(51) Int. Cl. G06F 17/50

(52) U.S. Cl. 716/11

(57) ABSTRACT

A method and an apparatus are disclosed for the display of hierarchical navigation in the automated design of integrated circuits under test. A user, using a computer, assigns a head pointer assignment and a tail pointer assignment, which form a definition of a viewable scope of at least one hierarchical level of design from a plurality of hierarchical levels of design. These head pointer and tail pointer assignments are stored in a repository of the computer to set the definition of the viewable scope of the at least one hierarchical level of design. After being set, the viewable scope of the at least one hierarchical level of design is displayed on a computer display device, where the viewable scope of the at least one hierarchical level of design can be traversed by moving a scrolling mechanism up and down in the viewable scope of the at least one hierarchical level of design.

### TECHNICAL FIELD

The present invention relates generally to physical design, development and manufacturing of integrated circuits (ICs) on semiconductor chips, for use in automated computing systems. More particularly, the present invention relates to an integrated circuit (IC) layout debugging method and tool.

### BACKGROUND

When conducting hierarchical design and physical development of ICs, designers often face the problem of having voluminous smaller designs at various levels of the IC topological design hierarchy. When a layout person needs to trace signal paths, which traverse numerous design hierarchies within the same design window, all the viewable hierarchical design levels distract the layout person trying to conduct a debugging process involving only a few targeted hierarchical levels. Although current electronic design automation tools offer methods of traversing design hierarchies within the same design window, none of these electronic design automation tools offer an easy interface to allow the user to traverse design hierarchies.

Therefore, the need exists for a hierarchical design navigation method and a navigation apparatus for use in debugging layout induced design errors including design rule check (DRC) violations and layout-to-schematic verification (LVS) violations.

An additional need exists for a convenient design hierarchy method and device, which can save time and effort in debugging and repairing these errors.

Further, the need exists for a scroll mechanism to traverse design hierarchical design levels allowing users to control a definable viewable scope at different levels of design hierarchy quickly, which in turn will aid the debugging process.

### SUMMARY OF THE INVENTION

A method and an apparatus are disclosed for the display of hierarchical navigation in the automated design of integrated circuits under test. A user, using a computer, assigns a head pointer assignment and a tail pointer assignment, which form a definition of a viewable scope of at least one hierarchical level of design from a plurality of hierarchical levels of design. The tail pointer assignment must be either equal to or greater than the head pointer assignment. These head pointer and tail pointer assignments are stored in a repository of the computer to set the definition of the viewable scope of the at least one hierarchical level of design. After being set, the viewable scope of the at least one hierarchical level of design is displayed on a computer display device, where the viewable scope of the at least one hierarchical level of design can be traversed by moving the viewable scope up and down, using a scrolling mechanism of the computer, and where the user controls the scrolling mechanism to perform the useful, concrete and tangible result of traversing the viewable scope of the at least one hierarchical level of design and conducting a debugging operation of the integrated circuit under test, without distractions from voluminous levels of IC topological information, of the plurality of hierarchical levels of design.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings, which are meant to be exemplary, and not limiting, wherein:

FIG. 1 illustrates operations in a method for the display of hierarchical navigation in the automated design of integrated circuits under test.

FIG. 2 illustrates a viewable scope of hierarchical levels of design as defined by a head pointer and a tail pointer.

FIG. 3 illustrates the system implementing the operations illustrated in FIG. 1.

### DETAILED DESCRIPTION

Exemplary embodiments of a method and an apparatus are disclosed for display of hierarchical navigation in the design automation process of the design, physical development and manufacturing of integrated circuits including head and tail pointers used to define the viewable scope of the desired design hierarchy to be traversed. The disclosed exemplary embodiments are intended to be illustrative only, since numerous modifications and variations therein will be apparent to those of ordinary skill in the art. In reference to the drawings, like numbers will indicate like parts continuously throughout the view. Further, the terms “a”, “an”, “first”, “second” and “third” herein do not denote limitations of quantity, but rather denote the presence of one or more of the referenced item(s).

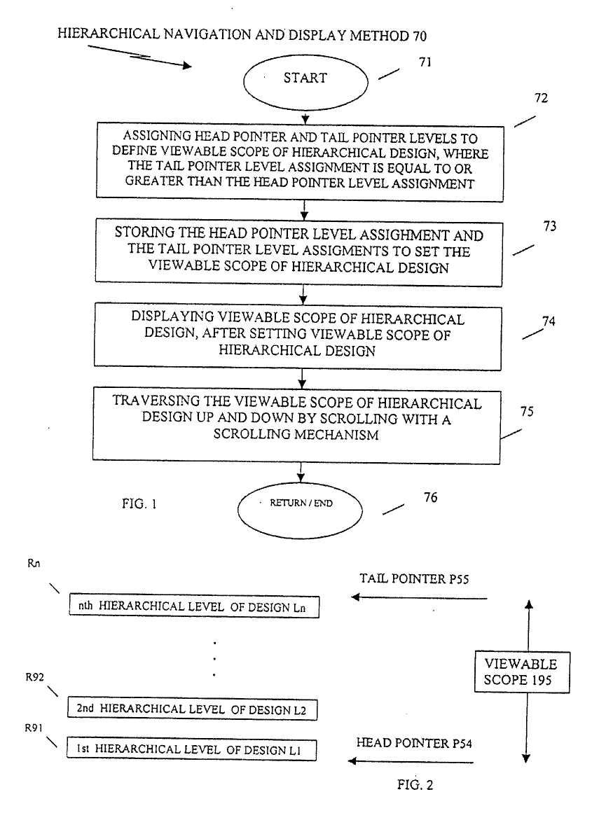

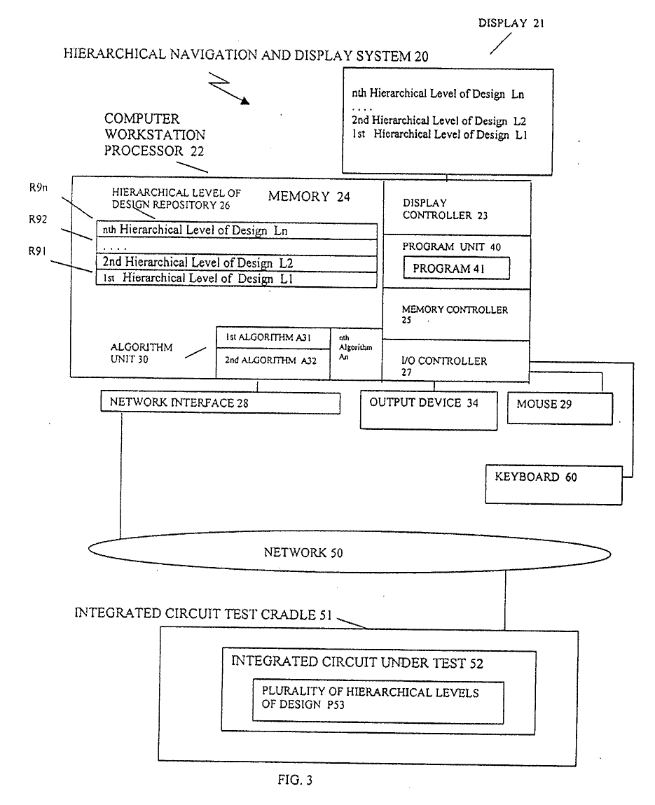

The hierarchical and display navigation method 70 (herein referred to as “method 70”) and the hierarchical navigation and display system 20 (herein referred to as “system 20”) implementing method 70 are illustrated in FIGS. 1 and 3, respectively. The viewable scope 195 of an exemplary hierarchical level of design is illustrated in FIG. 2.

Referring to FIG. 3, system 20 includes computer workstation processor 22, which contains memory 24. Algorithm unit 30 resides in memory 24 and contains a plurality of algorithms including first algorithm A31 and second algorithm A32 up to nth algorithm An. Also, residing in system 20 is program unit 40, containing program 41. Memory 24 also contains hierarchical level of design repository 26, which contains a plurality of repository entry locations R91, R92 and up to Rn, which hold hierarchical levels of design L1, L2 up to Ln.

In addition, system 20 includes a combination of controllers including display controller 23, memory controller 25 and input/output (I/O) controller 27 and a combination of computer peripheral devices cooperatively coupled to system 20 including display 21, a set of input devices including keyboard 60 and mouse 29, network interface 28, and output device 34, via standard interface connectivity. Network interface 28 cooperatively couples computer workstation processor 22 via network 50 to integrated circuit test cradle 51. An integrated circuit under test 52 is plugged into integrated circuit test cradle 51 to undergo testing and debugging exercises.

An integrated circuit under test 52 has a three dimensional layered topology of viewable design data comprising a plurality of hierarchical levels of design P53, which is composed of hierarchical levels of design L1, L2 up to Ln. Display 21 displays the plurality of hierarchical levels of design P53, when no limited viewable scope of hierarchical levels of design have been defined and set for viewing by the operator/user. In the alternative, display 21 displays only the viewable scope of hierarchical levels of design, which have been defined and set for viewing by the operator/user. By not displaying the viewable scope of the plurality of hierarchical levels of design, operator/user fatigue is reduced, causing the operator/user to make fewer mistakes in exercising the IC under test 52, during test and debugging operations in the IC design and development process.

Referring to FIG. 1, FIG. 2 and FIG. 3, at operation start 71, the operator/user activates program 41, where hierarchical navigation and display method 70 is stored as program code on a computer executable medium. The operator/user activates program 41 and performs other selections in method 70 by making entries using either keyboard 60 or mouse 29. At operation start 71, the user makes the selection to activate program 41; thus, causing program 41 to be executed by computer workstation processor 22. At operation 72, the user assigns head pointer P54 and tail pointer P55 to form the definition of the viewable scope 195 of at least one hierarchical level of design or multiple hierarchical levels of design L1, L2 and up to Ln from the plurality of hierarchical levels of design P53, where the value of “n” in Ln represents the maximum number of hierarchical levels of design that can be contained in the integrated circuit under test 52. The tail pointer assignment must be either equal to or greater than the head pointer assignment. If the tail pointer assignment is less than the head pointer assignment, then an error in the display is encountered and the viewable scope displayed is undefined.

After the tail pointer P54 and the head pointer P55 assignments have been made, defining the viewable scope 195 of the hierarchical level or levels of design, L1, 12 or up to Ln, the tail pointer P54 and the head pointer P55 assignments are stored in entry locations R91, R92 up to Rn of hierarchical level of design repository 26 by either the operator/user or automatically by program 41 setting the definition of the viewable scope 195 of the at least one hierarchical level of design of the plurality of hierarchical levels of design P53.

Once the viewable scope 195 of the at least one hierarchical level of design is set by storing the tail pointer P54 and head pointer P55 assignments in entry locations R91, R92 up to Rn of hierarchical level of design repository 26, program 41 calls a first algorithm A31 of a plurality of algorithms composed of first algorithm A1, second algorithm A2, up to nth algorithm An from algorithm unit 30 to cause the viewable scope 195 of the at least one hierarchical level of design which is defined to be displayed by display 21. Once the viewable scope 195 of the at least one hierarchical level of design is defined and displayed on display 21, the operator/user can use a scrolling device to traverse the viewable scope 195 of the at least one hierarchical level of design by activating and moving the scrolling device up and down causing a corresponding up and down moving of a cursor on the screen of display 21. In this embodiment, the scrolling device can be mouse 29 or a combination of keys when activated on keyboard 60.

Therefore, the execution of program 41 by computer workstation processor 22, causes computer workstation process 22 to implement the embodiment of method 70 and thus provide an engineering design aid that the operator/user has programmed to perform the useful, concrete and tangible result of controlling a scrolling device to traverse the viewable scope 195 of one or more hierarchical levels of design in a graphical layout of an integrated circuit under test 52 displayed by display 21 and conduct a debugging operation of the integrated circuit under test 52, without the distraction from voluminous layers of IC topological information and resulting information overload while traversing the plurality of hierarchical levels of design P53.

At operation 76, method 70 either repeatedly returns to operation 72 where the viewable scope 195 of additional hierarchical levels of design can be defined differently by assigning additional head pointer P54 and tail pointer P55 assignments, where additional iterations of the exercising of integrated circuit under test 52 are performed by the operator/user. In the exemplary embodiment, at operation 76, in accordance with method 70, the user can end the operation of method 70, by deactivating program 41 and ending the design debugging session.

While the disclosure has been described with reference to an exemplary method and system embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular exemplary embodiment disclosed as the best mode contemplated for carrying out this disclosure, but that the disclosure will include all embodiments falling within the scope of the appended claims.

What is claimed is:

1. A method of displaying hierarchical navigation in an automated design of an integrated circuit under test, the method comprising:
assigning, by a user, using an input device of a computer, a head pointer assignment and a tail pointer assignment forming a definition of a viewable scope of an at least one hierarchical level of design from a plurality of hierarchical levels of design, where the tail pointer assignment is one of equal to the head pointer assignment and greater than the head pointer assignment;
storing, in a repository of the computer, the head pointer assignment and the tail pointer assignment to set the definition of the viewable scope of the at least one hierarchical level of design;
displaying, on a display device of the computer, the viewable scope of the at least one hierarchical level of design; and
traversing the viewable scope of the at least one hierarchical level of design by moving the viewable scope up and down, using a scrolling mechanism of the computer, where a user controls the scrolling mechanism to perform a useful, concrete and tangible result of traversing the viewable scope of the at least one hierarchical level of design and conducting a debugging operation of the integrated circuit under test, without distractions from voluminous levels of IC topological information, of the plurality of hierarchical levels of design.

2. The method according to claim 1, further comprising performing one of ending the hierarchical navigation in the automated design of the integrated circuit under test and repeating the hierarchical navigation in the automated design of the integrated circuit under test by using a different definition of the viewable scope of the at least one hierarchical level of design from the plurality of hierarchical levels of design.

3. A system for displaying hierarchical navigation in an automated design of an integrated circuit under test, the system comprising:
a computer workstation processor;
a combination of computer peripheral devices connected to the computer workstation processor, where the combination of computer peripheral devices includes a display, a set of input devices including a keyboard and a mouse, an output device, and a network interface, where the network interface connects to a network, where the network is connected to an integrated circuit test cradle containing the integrated circuit under test, and the integrated circuit under test contains a plurality of hierarchical levels of design;
a combination of controllers residing in the computer workstation processor, where the combination of controllers includes a display controller, a memory controller and an input/output controller;
a memory, a program unit and an algorithm unit residing in the computer workstation processor, where the memory contains a repository for the hierarchical levels of design, the algorithm unit contains a plurality of algorithms and the program unit contains a program that when executed by the computer workstation processor, causes the computer workstation processor to:
assign, by a user, using an input device of the computer workstation processor, a head pointer assignment and a tail pointer assignment forming a definition of a viewable scope of an at least one hierarchical level of design from the plurality of hierarchical levels of design, where the tail pointer assignment is one of equal to the head pointer assignment and greater than the head pointer assignment;
store, in the repository of the hierarchical levels of design in the computer workstation processor, the head pointer assignment and the tail pointer assignment to set the definition of the viewable scope of the at least one hierarchical level of design;
display, on a display device of the computer workstation processor, the viewable scope of the at least one hierarchical level of design; and
traverse the viewable scope of the at least one hierarchical level of design by moving the viewable scope up and down, using a scrolling mechanism of the computer workstation processor, where a user controls the scrolling mechanism to perform a useful, concrete and tangible result of traversing the viewable scope of the at least one hierarchical level of design and conducting a debugging operation of the integrated circuit under test, without distractions from voluminous levels of IC topological information, of the plurality of hierarchical levels of design.

4. The system according to claim 3, where the system performs one of ending the hierarchical navigation in the automated design of the integrated circuit under test and repeating the hierarchical navigation in the automated design of the integrated circuit under test by using a different definition of the viewable scope of the at least one hierarchical level of design from the plurality of hierarchical levels of design.
